(19) United States
(12) Patent Application Publication
(10) Pub. No.: US 2021/0209514 A1
(43) Pub. Date: Jul. 8, 2021

(54) MACHINE LEARNING METHOD FOR INCREMENTAL LEARNING AND COMPUTING DEVICE FOR PERFORMING THE MACHINE LEARNING METHOD

(71) Applicant: Electronics and Telecommunications Research Institute, Daejeon (KR)

(72) Inventors: Chulho KIM, Sejong-si (KR); Ock Kee BAEK, Daejeon (KR); Young Choon WOO, Daejeon (KR); Sung Yup LEE, Daejeon (KR); Jung Hoon LEE, Daejeon (KR); In Moon CHOI, Daejeon (KR)

(73) Assignee: Electronics and Telecommunications Research Institute, Daejeon (KR)

(21) Appl. No.: 17/141,780

(22) Filed: Jan. 5, 2021

(30) Foreign Application Priority Data
Jan. 6, 2020 (KR) 10-2020-0001690
Dec. 22, 2020 (KR) 10-2020-0181204

(51) Int. Cl. G06N 20/20; G06K 9/62

(52) U.S. Cl. CPC G06N 20/20; G06K 9/6257

(57) ABSTRACT

A machine learning method for incremental learning builds a model by using training data and incrementally updates the built model by using only a new weight generated based on new training data.

### CROSS-REFERENCE TO RELATED APPLICATIONS

This application claims priority under 35 U.S.C. § 119 to Korean Patent Application No. 10-2020-0001690, filed on Jan. 6, 2020 and Korean Patent Application No. 10-2020-0181204, filed on Dec. 22, 2020, the disclosure of which is incorporated herein by reference in its entirety.

### TECHNICAL FIELD

The present invention relates to machine learning, and more particularly, to machine learning associated with incremental learning.

### BACKGROUND

In order to enhance the adaptability and reliability of supervised machine learning which is widely used in the field of artificial intelligence (AI), various researches are being done on incremental learning. The learning machine increases the adaptability of a model to a continuously changed environment.

A machine learning model based on an artificial neural network (ANN), such as a deep neural network (DNN), a convolutional neural network (CNN), or a recurrent neural network (RNN), has a problem of catastrophic forgetting (CF), and due to this, has a limitation in implementing incremental or continual learning. Also, an internal structure of the ANN-based machine learning model is very complicated, and due to this, it is difficult to describe a model or a result.

In the ANN-based machine learning model, when new learning data is input, the CF problem may occur where previously learned content is forgotten outside an optimized state (a previously learned state) corresponding to all of previous learning data, and due to this, the incremental enlargement (incremental update or incremental performance enhancement) of a model is difficult.

Various methods are being researched for improving the CF problem, but because many researches decrease the performance of a model, a method for effectively solving the CF problem is not yet developed.

With regard to multivariate numeric data or multivariate numeric heterogeneous data instead of an image, gradient boosting (GB) included in a decision tree-based ensemble technique has been proposed as an algorithm having better performance than an ANN-based algorithm. However, such a technique performs optimization on all of learning data in building a model, and due to this, may not easily provide incremental learning.

### SUMMARY

Accordingly, the present invention provides a machine learning method for easily performing incremental learning without a reduction in performance of a model and a computing device for performing the machine learning method.

In one general aspect, a machine learning method for incremental learning, performed by a computing device, includes: encoding training data labeled to a plurality of class labels; constructing features, included in the encoded training data, as nodes and connecting adjacent nodes of the nodes by using an edge representing connection strength to generate a plurality of feature networks classified into the plurality of class labels; determining feature networks, selected based on performance from among the generated plurality of feature networks, as significant feature networks; combining the determined significant feature networks to build a model; encoding new training data; calculating a new weight by using an instance of the encoded new training data to normalize the calculated new weight; and updating the weight of each of the determined significant feature networks on the basis of the normalized new weight to incrementally update the built mode.

In another general aspect, a computing device for executing a machine learning method for incremental learning includes: a processor; a storage configured to store training data labeled to a plurality of class labels and new training data; and a machine learning module configured to build a model by using the training data labeled to the plurality of class labels on the basis of control by the processor, wherein the machine learning module includes: an encoder configured to encode the training data labeled to the plurality of class labels and the new training data; a feature network generator configured to construct features, included in the encoded training data, as nodes and to connect adjacent nodes of the nodes by using an edge having a weight representing connection strength to generate a plurality of feature networks classified into the plurality of class labels; a significant feature network determiner configured to determine feature networks, selected based on performance from among the generated plurality of feature networks, as significant feature networks, to calculate a new weight by using an instance of the encoded new training data, and to normalize the calculated new weight; a model builder configured to combine the determined significant feature networks to build a model; and an update unit configured to update the weight of each of the determined significant feature networks on the basis of the normalized new weight to incrementally update the built mode.

Other features and aspects will be apparent from the following detailed description, the drawings, and the claims.

### BRIEF DESCRIPTION OF THE DRAWINGS

FIG. 1 is a flowchart for describing a machine learning method for incremental learning, according to an embodiment of the present invention.

FIG. 2 is a diagram for describing a feature sequence selected through a step of selecting a feature sequence illustrated in FIG. 1.

FIG. 3 is a diagram for schematically describing a model building step S400 illustrated in FIG. 1.

FIG. 4 is a diagram for describing an ensemble configuration of each sub-model illustrated in FIG. 1.

FIG. 5 is a block diagram of a computing device implemented to perform a machine learning method for incremental learning, according to an embodiment of the present invention.

### DETAILED DESCRIPTION OF EMBODIMENTS

In embodiments of the present invention disclosed in the detailed description, specific structural or functional descriptions are merely made for the purpose of describing embodiments of the present invention. Embodiments of the present invention may be embodied in various forms, and the present invention should not be construed as being limited to embodiments of the present invention disclosed in the detailed description.

Embodiments of the present invention are provided so that this disclosure will be thorough and complete, and will fully convey the concept of the present invention to one of ordinary skill in the art. Since the present invention may have diverse modified embodiments, preferred embodiments are illustrated in the drawings and are described in the detailed description of the present invention. However, this does not limit the present invention within specific embodiments and it should be understood that the present invention covers all the modifications, equivalents, and replacements within the idea and technical scope of the present invention.

In the following description, the technical terms are used only for explaining a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

The present invention relates to a supervised learning algorithm for easily performing incremental learning which is not efficiently implemented in conventional machine learning. The present invention may discover significant feature networks (SNNs) corresponding to significant features, construct a learning model by using a correlation between values included in a feature combination on the basis of learning data, and use the constructed learning model to classify and predict new data, in a supervised learning method of predicting a label of a target variable in data including a plurality of variables or features and the target variable.

The present invention may add an incremental variation to a previous model to construct a new model including a new data set, in a case which additionally learns a previously built model by using the new data set, and thus, may enable incremental learning to be easily performed.

Hereinafter, a machine learning method for incremental learning according to an embodiment of the present invention will be described in detail with reference to the accompanying drawings. Also, the following embodiments relate to supervised learning for classification. However, the present invention is not limited thereto, and it may be sufficiently understood by those skilled in the art that the present invention may be applied to supervised learning for regression, based on the following description.

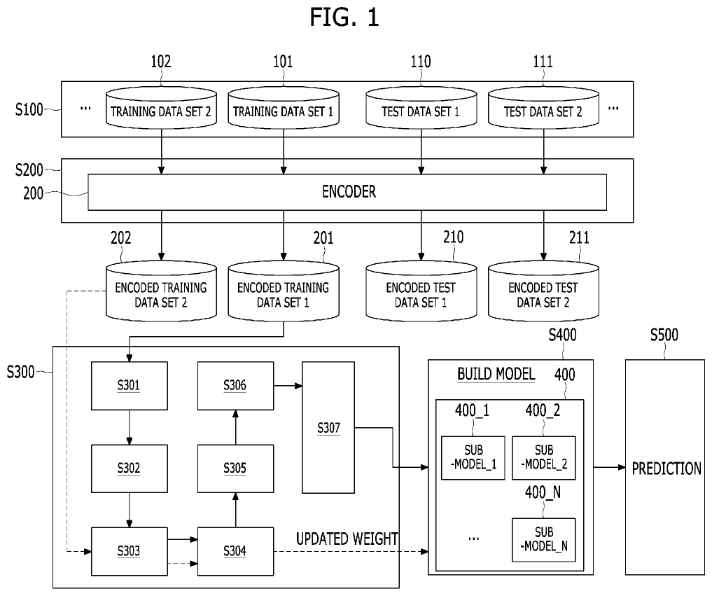

FIG. 1 is a flowchart for describing a machine learning method for incremental learning, according to an embodiment of the present invention.

The machine learning method for incremental learning, according to an embodiment of the present invention may include a step of performing learning and prediction on a single data set and a step of performing incremental learning on an additional data set.

The step of performing learning and prediction on a single data set will be described first, and then, the step of performing incremental learning on an additional data set will be described.

Step of Performing Learning and Prediction on Single Data Set

Referring to FIG. 1, a step of performing learning and prediction on a single data set may include step S100 of preparing a plurality of training data sets 101 and 102 and a plurality of test data sets 110 and 111, step S200 of performing encoding, step S300 of discovering a significant feature network (SFN), step S400 of building a model, and step S500 of performing prediction.

A. Step S100 of Preparing Training Data Set and Test Data Set

The training data set 101 may include pieces of training data labeled to a plurality of class labels so as to build a model (400: 400_1, 400_2, . . . and 400_N).

Each training data may include multi-dimensional features and a target feature (or variable) based on a class label. Each feature (or variable) may include a continuous or discrete number or letter value.

The test data set 110 may have the same configuration as that of the training data set 101, but may have a difference in that the test data set 110 is used for testing the prediction performance of a previously built model.

The training data set 101 and the test data set 110 may be divided into a before-encoding data set and an after-encoding data set. A before-encoding training data set 101 and a before-encoding test data set 110 may be respectively referred to as a raw training data set and a raw test data set.

B. Encoding Step S200

In the encoding step S200, a process of encoding the training data set 101 and the test data set 110 by using an encoder 200 may be performed. The encoding may process the training data set 101 into data suitable for training (or learning) of the model 400 and may be a process of processing the test data set 110 into data suitable for the test of the model 400.

When a value of an arbitrary feature is continuous, the encoding step S200 may convert the value into a discrete value, a discontinuous value, or a categorical value, or may be an operation of converting a text-based value into an appropriate number value.

An operation of converting a continuous value of an arbitrary feature into a discrete value or a categorical value or converting a letter-based value into a number value may be changed based on a previously defined (or programmed) encoding rule. The encoding rule may be static or dynamic in an overall process of learning and prediction.

Moreover, the encoding step S200 may be an operation of re-setting a section of a discrete or categorical value or an operation of converting an input value into a different value. Here, the operation of re-setting a section of a discrete or categorical value may be, for example, an operation of re-setting values divided into 10 steps to 5 steps, and the operation of converting an input value into a different value may be, for example, an operation of converting values set to −2, −1, 0, 1, and 2 to 1, 2, 3, 4, and 5.

C. SFN Discovering Step S300

The SFN discovering step S300 may be an operation of discovering an SFN corresponding to a main element of the model 400 by using a training data set 201 encoded by the encoder 200. Here, the discovering of the SFN may be an operation of detecting, extracting, or calculating an SFN by using the encoded training data set 201.

In detail, the SNF discovering step S300 may include, for example, step S301 of generating a feature sequence, step S302 of forming a node and an edge, step S303 of calculating a weight, step S304 of normalizing a weight, step S305 of assessing a feature network, step S306 of ranking the feature network, and step S307 of selecting an SFN.

The SFN may be obtained (or discovered, detected, extracted, or calculated) through a process of iterating the steps S301 to S306, and in the SNF selecting step S307, a process of selecting a specific feature sequence, determined as high priority in the feature network ranking step S306, as an SFN may be performed. A model may be constructed by using the selected SFN. Hereinafter, each of the steps for obtaining an SFN will be described in detail.

C-1 Feature Sequence Generating Step S301

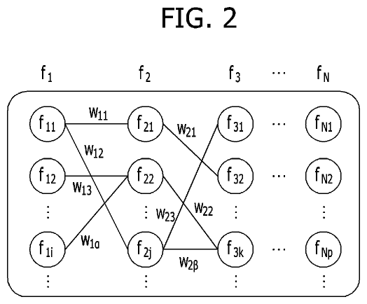

FIG. 2 is a diagram for describing an example of a feature sequence generated through the feature sequence generating step S301 illustrated in FIG. 1.

Referring to FIG. 2, a feature sequence may denote that two or more features (or two or more generated features) are selected from the encoded training data set 201 including a plurality of features and are sorted in a specific order.

With regard to a feature sequence, for example, when N (where N is an integer of 2 or more) number of features are selected from among all features and are sorted in a specific order, a specific sequence “f₁, f₂, f₃, . . . , and f_{N}” may be generated as illustrated in FIG. 2.

A method of generating a specific feature sequence may be divided into a method of selecting a feature without varying a feature and a method of generating a new feature on the basis of features include in the encoded training data set 201.

A feature selecting method for generating a feature sequence may include, for example, various methods such as a random selection method, a method based on all combinations, a method of obtaining a feature through a different machine learning method, and a method of using mutual information about information theory.

The feature selecting method for generating a feature sequence may include, for example, various methods such as linear discriminant analysis (LDA), principal component analysis (PCA), and a method based on a deep learning-based feature extracting method such as Autoencoder.

C-2 Step S302 of Forming Node and Edge

When a specific feature sequence is selected through step S301, a node and an edge may be defined, and thus, a feature network may be constructed.

Each of nodes “f₁₁, f₁₂, . . . , f₁ᵢ, f₂₁, f₂₂, . . . , f_{N1}, f_{N2}, f_{NP}, . . . ”, as illustrated in FIG. 2, may be defined as encoded values of each of features “f₁, f₂, f₃, . . . , and f_{N}”, and each of edges “w₁₁, w₁₂, w₁₃, w_{1α}, w₂₁, w₂₂, w₂₃, w_{2β}, . . . ” may define a connection between adjacent nodes. Here, the feature f₂ may include nodes “f₂₁, f₂₂, . . . , and f₂ⱼ”, and the nodes may be connected to nodes of adjacent features f1 and f3 by an edge (or a connection line representing a weight). Based on a connection between a node and an edge, a feature network corresponding to a selected feature sequence may be constructed.

C-3 Weight Calculating Step S303

An edge connecting nodes may have a specific value, and the specific value may be defined as a weight representing connection strength of nodes. The weight may be obtained from the encoded training data set 201. When an instance of the encoded training data set 201 is input, a weight of an edge connecting nodes activated by the instance may be calculated. Here, the instance may denote an example or a sample, which constitutes data when the data needed for learning or inference (or prediction) of a machine learning model is assigned. Therefore, the instance may be referred to as a training example or a training sample, which constitutes training data.

A weight may be calculated based on a predefined weight calculation rule. A weight calculating method may include a method of dividing a network by class units to update a weight.

For example, when training data having three class labels “1, 2, and 3” is assigned, three feature networks based on the same feature sequence may be generated, training data having No. 1 class label may be used to calculate a weight of No. 1 network, training data having No. 2 class label may be used to calculate a weight of No. 2 network, and training data having No. 3 class label may be used to calculate a weight of No. 3 network. This may denote that feature networks having different weights are generated based on a class label in association with one feature sequence.

C-4 Weight Normalizing Step S304

When a weight of an edge is calculated based on a plurality of instances included in the encoded training data set 201, a process of normalizing the calculated weight may be performed.

The normalization process may be performed based on a predefined weight normalization rule. Here, the weight normalization rule may be, for example, a rule where a sum of edges between two adjacent features is set to 1.

C-5 Feature Network Assessing Step S305

The feature network assessing step S305 may be a step of calculating a network assessing index representing the degree of performance in a case where a corresponding feature network determines a class, based on pieces of weight information and a feature network generated by through the steps.

There may be two methods for assessing a feature network.

A first method may be a method of mathematically extracting a figure of merit from a characteristic included in weight information of a feature network. A second method of calculating an accuracy of determining a class to assess the performance of feature networks, by using a plurality of feature networks, the normalized weight, and an instance labeled to a class label which is not used (or used) to calculate a weight. All of the methods may arithmetically assess a feature network.

C-6 Feature network ranking step S306 Apriority of a feature network may be determined based on a feature network assessing index arithmetically calculated as a result of step S305. In first performing, a first-selected feature network may be No. 1 priority, but in a case where another feature network is selected in step S301 and processes up to S306 are iterated, priority may be changed. Priority may be represented by a subscript like SFN₁, SFN₂, SFN₃, . . . .

C-7 SFN Selecting Step S307

A predetermined number of feature networks ranked as having high priority in step S306 may be selected. The selected feature networks may be used to build a model as SFNs.

D. Step S400 of Building Model

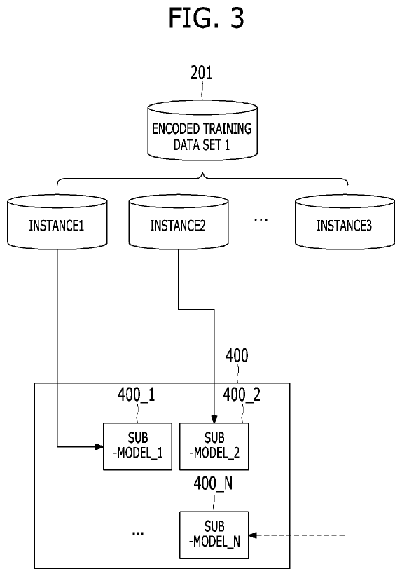

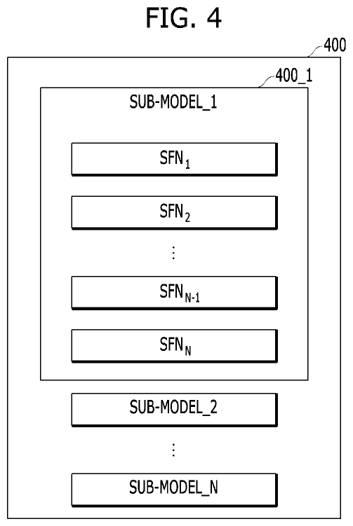

FIG. 3 is a diagram for schematically describing a model building step S400 illustrated in FIG. 1. FIG. 4 is a diagram for describing an ensemble configuration of each sub-model illustrated in FIG. 1.

Referring to FIG. 3, model building step S400 may be a step of constructing a model by using an SFN which is selected through step S307. Each model 400 may be configured with a plurality of sub-models divided by class units.

As illustrated in FIG. 1, a model built to differentiate N number of classes may include N number of sub-models 400_1 to 400_N. Also, as illustrated in FIG. 4, each of the sub-models may be configured as an ensemble where SFNs selected in step S307 are combined.

A method of constructing a fundamental ensemble may be a method where all sub-models are built by using SFNs. Also, in a case which updates a weight by using training data, as illustrated in FIG. 3, an instance of the training data may be used to calculate and update a weight of an SFN of a sub-model corresponding to each class label. When a training process ends, generated sub-models may be configured with the same SFNs, but may have pieces of different weight information.

E. Prediction Step S500

Prediction step S500 may be a process of inputting an instance of the test data set 110 to all of the sub-models 400_1 to 400_N included in the built model 400 to select a sub-model, having a highest weight score, as a prediction class of a corresponding instance.

A weight score of a specific sub-model corresponding to the instance of the test data set 110 may be calculated by using a weight score of each of SFNs configuring a corresponding sub-model.

As illustrated in FIG. 4, a weigh score of a sub-model 1 may be calculated as a linear combination of weight scores of SFNs configuring sub-models such as SFN1 (S311), SFN2 (S312), and SFN3 (S313).

In an i^{th} (where i is an integer of 2 or more) instance Di of the test data set 110, W(Dᵢ, SFNⱼ) may be assumed to be a weight score of SFN. In this case, a weight score W₁(Dᵢ) of the sub-model 1 may be calculated as expressed in the following Equation 1.

$${W}_{1} ( {D}_{i} ) = {\sum }_{j} {c}_{j} \cdot W ( {D}_{i} , {SFN}_{j} ) \qquad [ Equation 1 ]$$

Here, cⱼ may denote a coefficient representing a level of contribution with respect to a priority of an SFN. For example, when cⱼ is 1, a weight score may be calculated at an equal ratio for each SFN regardless of priority. In this case, a cⱼ value may be differently set based on j (based on an SFN) for each of different priorities.

Step of Performing Incremental Learning on Additional Data Set

One of significant characteristics of the present invention may be that incremental learning is easily performed on newly-added training data 102. First, it may be assumed that the model 400 is built based on a training data set 1 101. Subsequently, a new training data set 2 102 may be input to the encoder 200.

The encoder 200 may perform encoding on the new training data set 2 102 to generate an encoded training data set 2 102.

Subsequently, only weight calculating step S303 and weight normalizing step S304 may be sequentially performed on the encoded training data set 2 102, instead of performing all steps S301 to S307 included in step S300 of discovering an SFN, and thus, incremental learning may be performed based on a normalized weight of the encoded training data set 2 102 by using a method of updating a weight of a built model 400.

In such incremental learning, when new training data is input, a built model may be maintained and learning may be performed by updating only a state variable which is a weight, and thus, incremental learning may be easily performed.

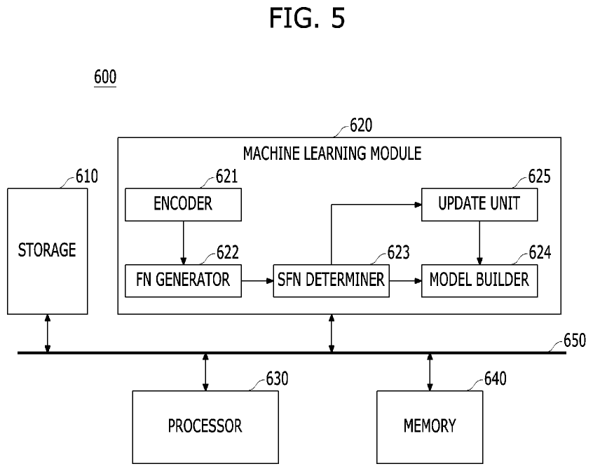

FIG. 5 is a block diagram of a computing device 600 implemented to perform a machine learning method for incremental learning, according to an embodiment of the present invention.

Referring to FIG. 5, the computing device 600 may include a storage 610, a machine learning module 620, a processor 630, a memory 640, and a system bus 650 connecting the elements 610 to 640.

The storage 610 may be a hardware device which stores test data (or a test data set) 110 and 111 and training data (or a training data set) 102 labeled to a plurality of class labels for building a model (400 of FIG. 1) and stores new training data (or a new training data set) 102 for incrementally updating the model 400 through incremental learning.

The storage 610 may be, for example, a computer-readable medium, and for example, may include a magnetic medium such as a hard disk, a floppy disk, and a magnetic tape, an optical recording medium such as CD-ROM and DVD, and a magnetic optical medium such as a floptical disk.

The machine learning module 620 may be a hardware module or a software module, which builds the model 400 on the basis of control or execution by the processor 630 and incrementally updates (or learns) the built model 400 by using only a new weight generated based on the new training data 102.

The machine learning module 620 may include a plurality of lower modules classified based on a function, and the plurality of lower modules may include, for example, an encoder 621, a feature network (FN) generator 622, an SFN determiner 623, a model builder 624, and an update unit 625.

The encoder 621 may be an element which encodes training data labeled to a plurality of class labels, and for example, may perform a process of step S200 described above with reference to FIG. 1. The encoder 621 may convert a continuous value of a feature, included in the training data, into a discrete value or a categorical value on the basis of a predefined encoding rule.

Moreover, the encoder 621 may encode the new training data 102, for generating a new weight based on the new training data 102.

The FN generator 622 may be an element which constructs features, included in the encoded training data, as nodes and connects adjacent nodes of the nodes by using an edge having a weight representing connection strength to generate a plurality of feature networks classified into the plurality of class labels, and may be an element which performs steps S301 and S302 described above with reference to FIG. 1.

The FN generator 622 may sort two or more features, included in the encoded training data, in a specific order by performing step S301, thereby generating a feature sequence.

For example, the FN generator 622 may randomly select two or more features from the encoded training data and may sort the randomly selected two or more features in the specific order to generate the feature sequence.

As another example, the FN generator 622 may convert the two or more features, included in the encoded training data, into new features by using the LDA, the PCA, and the deep learning-based feature extracting technique, and then, may sort the new features in a specific order to generate the feature sequence.

When the feature sequence is generated, the FN generator 622 may construct values, included in the sorted features, as nodes and may connect adjacent nodes of the nodes in the specific order by using the edge to generate a plurality of feature networks classified into the plurality of class labels on the basis of the generated feature sequence.

The SFN determiner 623 may determine feature networks, selected based on performance from among the generated plurality of feature networks, as SFNs.

For example, the SFN determiner 623 may calculate the weight of each of the plurality of feature networks by using an instance of the encoded training data 201 (S303 of FIG. 1), perform a process of normalizing the calculated weight, and perform a process (S305 of FIG. 1) of assessing performance of each of feature networks by using the plurality of feature networks and the normalized weight.

Additionally, the SFN determiner 623 may calculate a new weight by using an instance of the new training data 202 encoded by the encoder 200 through step S303 of FIG. 1 and may perform a process of normalizing the new weight calculated through step S304 of FIG. 1.

Subsequently, the SFN determiner 623 may determine priorities of the plurality of feature networks on the basis of the assessed performance (S306 of FIG. 1), and then, may perform a process (S307 of FIG. 1) of determining, as the SFNs, feature networks ranked as having a priority from among the plurality of feature networks on the basis of a predetermined number.

In a case where the plurality of class labels include a first class label and a second class label and the plurality of feature networks include a first feature network and a second feature network, for example, a process of normalizing the weight calculated by the SFN determiner 623 may include a process of calculating a weight of the first feature network by using an instance of the training data labeled to the first class label, a process of calculating a weight of the second feature network differing from the weight of the first feature network by using an instance of the training data labeled to the second class label, and a process of normalizing the weight of the first feature network and the weight of the second feature network.

A process of assessing performance of each feature network by using the SFN determiner 623 may include a process of calculating an accuracy of determining a class by using the plurality of feature networks, the normalized weight, and an instance labeled to a class label and a process of assessing performance of each of the feature networks on the basis of the calculated accuracy of determining a class.

The model builder 624 may perform a process of combining the SFNs determined by the SFN determiner 623 to build a model 400.

The update unit 625 may perform a process of incrementally updating the model 400 built by the model builder 624 on the basis of a new weight normalized by the SFN determiner 623.

For example, the update unit 625 may add the normalized new weight to the weight of each of the determined SFNs to incrementally update the built model.

The processor 630 may be an element which controls and manages operations of the storage 610, the machine learning module 620, and the memory 640 through the system bus 650 and may be at least one central processing unit (CPU), at least one graphics processing unit (GPU), or a combination thereof.

In FIG. 5, the processor 630 and the machine learning module 620 are illustrated as separate elements, but are not limited thereto and may be integrated as one body. For example, the machine learning module 620 may be integrated into the processor 630.

The memory 640 may be a hardware device which temporarily or permanently stores intermediate data or result data processed by each element of the processor 630 or the machine learning module 620 and may include a hardware device which is specially configured to store and execute a program instruction like read only memory (ROM), random access memory (RAM), and flash memory.

An example of the program instruction may include a machine code generated by a compiler and a high-level language code executable by a computer by using an interpreter or the like. The hardware device described above may be configured to operate as one or more software modules for performing an operation according to the present invention, and vice versa.

According to the embodiments of the present invention, when new learning data is being input, a previously built model may be maintained and may be learned by using only a weight generated based on new learning data, and thus, a model may be updated without changing a structure the previously built model, whereby incremental learning may be easily performed.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A machine learning method for incremental learning, performed by a computing device, the machine learning method comprising:
encoding training data labeled to a plurality of class labels;
constructing features, included in the encoded training data, as nodes and connecting adjacent nodes of the nodes by using an edge representing connection strength to generate a plurality of feature networks classified into the plurality of class labels;
determining feature networks, selected based on performance from among the generated plurality of feature networks, as significant feature networks;
combining the determined significant feature networks to build a model;
encoding new training data;
calculating a new weight by using an instance of the encoded new training data to normalize the calculated new weight; and
updating the weight of each of the determined significant feature networks on the basis of the normalized new weight to incrementally update the built mode.

2. The machine learning method of claim 1, wherein the encoding of the training data comprises converting a continuous value of a feature, included in the training data, into a discrete value or a categorical value on the basis of a predefined encoding rule.

3. The machine learning method of claim 1, wherein the generating of the plurality of feature networks comprises:
sorting two or more features, included in the encoded training data, in a specific order to generate a feature sequence; and
constructing values, respectively included in the sorted features, as nodes and connecting adjacent nodes of the nodes in the specific order by using the edge to generate a plurality of feature networks classified into the plurality of class labels on the basis of the generated feature sequence.

4. The machine learning method of claim 3, wherein the generating of the feature sequence comprises:
randomly selecting two or more features from the encoded training data; and
sorting the randomly selected two or more features in the specific order to generate the feature sequence.

5. The machine learning method of claim 3, wherein the generating of the feature sequence comprises converting two or more features, included in the encoded training data, into new features by using linear discriminant analysis (LDA), principal component analysis (PCA), and a deep learning-based feature extracting technique; and
sorting the new features in a specific order to generate the feature sequence.

6. The machine learning method of claim 1, wherein the determining of the selected feature networks as the significant feature networks comprises:
calculating the weight of each of the plurality of feature networks by using an instance of the training data and normalizing the calculated weight;
assessing performance of each of feature networks by using the plurality of feature networks and the normalized weight;
determining priorities of the plurality of feature networks on the basis of the assessed performance; and
determining, as the significant feature networks, feature networks ranked as having a priority from among the plurality of feature networks on the basis of a predetermined number.

7. The machine learning method of claim 6, wherein the normalizing of the calculated weight comprises:
in a case where the plurality of class labels include a first class label and a second class label and the plurality of feature networks include a first feature network and a second feature network,
calculating a weight of the first feature network by using an instance of the training data labeled to the first class label;
calculating a weight of the second feature network differing from the weight of the first feature network by using an instance of the training data labeled to the second class label; and
normalizing the weight of the first feature network and the weight of the second feature network.

8. The machine learning method of claim 6, wherein the assessing of the performance of each of the feature networks comprises:
calculating an accuracy of determining a class by using the plurality of feature networks, the normalized weight, and an instance labeled to a class label; and
assessing performance of each of the feature networks on the basis of the calculated accuracy of determining a class.

9. The machine learning method of claim 1, wherein the incrementally updating of the built model comprises adding the normalized new weight to the weight of each of the determined significant feature networks to incrementally update the built model.

10. A computing device for executing a machine learning method for incremental learning, the computing device comprising:
a processor;
a storage configured to store training data labeled to a plurality of class labels and new training data; and
a machine learning module configured to build a model by using the training data labeled to the plurality of class labels on the basis of control by the processor,
wherein the machine learning module comprises:
an encoder configured to encode the training data labeled to the plurality of class labels and the new training data;
a feature network generator configured to construct features, included in the encoded training data, as nodes and to connect adjacent nodes of the nodes by using an edge having a weight representing connection strength to generate a plurality of feature networks classified into the plurality of class labels;
a significant feature network determiner configured to determine feature networks, selected based on performance from among the generated plurality of feature networks, as significant feature networks, to calculate a new weight by using an instance of the encoded new training data, and to normalize the calculated new weight;
a model builder configured to combine the determined significant feature networks to build a model; and
an update unit configured to update the weight of each of the determined significant feature networks on the basis of the normalized new weight to incrementally update the built mode.

11. The computing device of claim 10, wherein the feature network generator performs a first process of sorting two or more features, included in the encoded training data, in a specific order to generate a feature sequence and a second process of constructing values, respectively included in the sorted features, as nodes and connecting adjacent nodes of the nodes in the specific order by using the edge to generate a plurality of feature networks classified into the plurality of class labels on the basis of the generated feature sequence.

12. The computing device of claim 10, wherein the significant feature network determiner performs a first process of calculating the weight of each of the plurality of feature networks by using an instance of the training data and normalizing the calculated weight, a second process of assessing performance of each of feature networks by using the plurality of feature networks and the normalized weight, a third process of determining priorities of the plurality of feature networks on the basis of the assessed performance, and a fourth process of determining, as the significant feature networks, feature networks ranked as having a priority from among the plurality of feature networks on the basis of a predetermined number.

13. The computing device of claim 10, wherein the update unit performs a process of adding the normalized new weight to the weight of each of the determined significant feature networks to incrementally update the built model.
